(19) United States
(12) Patent Application Publication
(10) Pub. No.: US 2026/0235533 A1
(43) Pub. Date: Aug. 13, 2026

(54) APPARATUS AND METHODS TO DETERMINE HOLE BLOCKAGE IN A SHOWERHEAD

(71) Applicant: Lam Research Corporation, Fremont, CA (US)

(72) Inventors: Bruce Christopher Bingham, West Linn, OR (US); Aleksey V. Altecor, Newberg, OR (US); Curtis W. Bailey, West Linn, OR (US); Yogesh Babbar, Hillsboro, OR (US)

(73) Assignee: Lam Research Corporation, Fremont, CA (US)

(21) Appl. No.: 19/470,711

(22) PCT Filed: Apr. 25, 2024
(86) PCT No.: PCT/US2024/026176

§ 371 Date: Sep. 29, 2025

Related U.S. Application Data
(60) Provisional application No. 63/500,866, filed on May 8, 2023.

(51) Int. Cl. G01N 21/954; G01N 21/88

(52) U.S. Cl. CPC G01N 21/954; G01N 21/8806; G01N 2201/0806

(57) ABSTRACT

Method of operating an apparatus to determine hole blockage in a showerhead includes operating an illumination structure to direct light into a cavity within the showerhead. In at least one implementation, a method further includes collecting the light emanating from exit holes in the showerhead and analyzing intensity of the light emanating from the exit holes to determine blockage of the exit holes.

### CLAIM FOR PRIORITY

This application claims priority to U.S. Provisional Patent Application No. 63/500,866, filed on May 8, 2023, titled “APPARATUS AND METHODS TO DETERMINE HOLE BLOCKAGE IN A SHOWERHEAD,” which is incorporated by reference in its entirety for all purposes.

### BACKGROUND

Substrate processing for etch and deposition form a backbone of the semiconductor industry. While a variety of processing techniques may be utilized, virtually all processes utilize a showerhead to deliver process gases to a substrate awaiting process. A showerhead can be used to distribute gas over an entire substrate. Distribution of holes in showerheads may be designed to provide process uniformity during etch or deposition. While formation of holes may be carried out by machining, examining integrity of holes formed is important during fabrication as well as during a lifetime of the showerhead. As such, methods are being investigated to accomplish effective examination of holes in showerheads.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Also, various physical features may be represented in their simplified “ideal” forms and geometries for clarity of discussion, but it is nevertheless to be understood that practical implementations may only approximate the illustrated ideals. For example, smooth surfaces and square intersections may be drawn in disregard of finite roughness, corner-rounding, and imperfect angular intersections, characteristic of structures formed by nanofabrication techniques. Further, where considered appropriate, reference labels have been repeated among the figures to indicate corresponding or analogous elements.

FIG. 1A is an isometric illustration of a showerhead, in accordance with at least one implementation.

FIG. 1B illustrates a cross-section of a showerhead and a light source directing light into a cavity within the showerhead, in accordance with at least one implementation.

FIG. 2A illustrates a cross-section of an illumination structure comprising a light pipe coupled with a light source, in accordance with at least one implementation.

FIG. 2B is a plan view illustration of a light pipe structure, in accordance with at least one implementation.

FIG. 2C is a plan view illustration of a light pipe structure, in at least one implementation.

FIG. 3A illustrates a cross-section of an illumination structure comprising at least one light source coupled with a rod, in accordance with at least one implementation.

FIG. 3B is a plan view illustration through a line A-A′ of the structure in FIG. 3A, in accordance with at least one implementation.

FIG. 4 illustrates a flow diagram of a method to measure hole blockage, in accordance with at least one implementation.

FIG. 5 illustrates a cross-section of utilization of light source depicted in FIG. 2A to measure blockage in holes in a showerhead, in accordance with at least one implementation.

FIG. 6A illustrates light transmitted through holes in a showerhead, as recorded by a light sensitive film, in accordance with at least one implementation.

FIG. 6B illustrates an enhanced illustration of a portion of light sensitive film, showing one or more blocked holes, in accordance with at least one implementation.

FIG. 6C illustrates an enhanced illustration of a portion of light sensitive film, showing one or more blocked holes, in accordance with at least one implementation.

FIG. 7A illustrates cross sectional enhancements of holes shown in FIG. 6A, in accordance with at least one implementation.

FIG. 7B illustrates a recording image of a partially blocked hole, in accordance with at least one implementation.

FIG. 7C illustrates a recording image of a partially blocked hole, in accordance with at least one implementation.

FIG. 8A is an enhanced cross-sectional illustration of an illumination structure comprising a light pipe inserted into an entrance hole of a showerhead, in accordance with at least one implementation.

FIG. 8B is a cross-sectional portion of cone-shaped recess, in accordance with at least one implementation.

FIG. 8C is an isometric illustration of a portion of light pipe having a conical recess with a surface that is coated with reflective material, in accordance with at least one implementation.

FIG. 8D is an isometric illustration of a portion of light pipe having a pyramidal recess, in accordance with at least one implementation.

FIG. 8E is an isometric illustration of a portion of light pipe having a pyramidal recess with a surface that is coated with reflective material, in accordance with at least one implementation.

FIG. 9A is an enhanced cross-sectional illustration of an illumination structure comprising a light pipe inserted into an entrance hole of a showerhead, in accordance with at least one implementation.

FIG. 9B is an enhanced cross-sectional illustration of an illumination structure comprising a light pipe inserted into an entrance hole of a showerhead, in accordance with at least one implementation.

FIG. 10 is an enhanced cross-sectional illustration of an illumination structure comprising a light source inserted into an entrance hole of a showerhead, in accordance with at least one implementation.

FIG. 11A is an enhanced cross-sectional illustration of an implementation of a light pipe inserted into a showerhead comprising a deflector, in accordance with at least one implementation.

FIG. 11B is an enhanced cross-sectional illustration of an implementation of a light source directing light into a showerhead comprising a deflector, in accordance with at least one implementation.

FIG. 11C is an enhanced cross-sectional illustration of an implementation of a fiber optic cable inserted into a showerhead comprising a deflector, in accordance with at least one implementation.

FIG. 12A is an isometric illustration of a showerhead illustrated in FIG. 1A coupled with an illumination structure using a mounting structure, in accordance with at least one implementation.

FIG. 12B is an isometric illustration through a mid-plane of structure in FIG. 12A, in accordance with at least one implementation.

### DETAILED DESCRIPTION

In at least one implementation, apparatus and methods to measure hole blockage in a showerhead in a processing tool is described. Here, numerous specific details are set forth, such as structural schemes to provide a thorough understanding of implementations of present disclosure. It will be apparent to one skilled in art that implementations of present disclosure may be practiced without these specific details. In other instances, well-known features, such as radio frequency sources, are described in lesser detail to not unnecessarily obscure implementations of present disclosure. Furthermore, it is to be understood that various implementations shown in figures are illustrative representations and are not necessarily drawn to scale.

In some instances, well-known methods and devices are shown in block diagram form, rather than in detail, to avoid obscuring present disclosure. Reference throughout this specification to “an implementation” or “one implementation” or “some implementations” means that a particular feature, structure, function, or characteristic described in connection with an implementation is included in at least one implementation. Thus, appearances of phrase “in an implementation” or “in one implementation” or “some implementations” in various places throughout this specification are not necessarily referring to same implementation of disclosure. Furthermore, particular features, structures, functions, or characteristics may be combined in any suitable manner in one or more implementations. For example, a first implementation may be combined with a second implementation anywhere particular features, structures, functions, or characteristics associated with two implementations are not mutually exclusive.

Here, “coupled” and “connected,” along with their derivatives, may be used herein to describe functional or structural relationships between components. These terms are not intended as synonyms for each other. Rather, in particular implementations, “connected” may be used to indicate that two or more elements are in direct physical, optical, or electrical contact with each other. “Coupled” may be used to indicate that two or more elements are in either direct or indirect (with other intervening elements between them) physical, electrical or in magnetic contact with each other, and/or that two or more elements co-operate or interact with each other (e.g., as in a cause-and-effect relationship).

Here, “over,” “under,” “between,” and “on” may generally refer to a relative position of one component or material with respect to other components or materials where such physical relationships are noteworthy. Unless these terms are modified with “direct” or “directly,” one or more intervening components or materials may be present. Similar distinctions are to be made in context of component assemblies. As used throughout this description, and in claims, a list of items joined by “at least one of” or “one or more of” can mean any combination of listed terms.

Here, “adjacent” may generally refer to a position of a thing being next to (e.g., immediately next to or close to with one or more things between them) or adjoining another thing (e.g., abutting it).

Unless otherwise specified in explicit context of their use, terms “substantially equal,” “about equal” and “approximately equal” mean that there is no more than incidental variation between two things so described. In at least one implementation, such variation is no more than +/−10% of a referred value.

Processing tools are utilized to accomplish a variety of deposition and etch processes in semiconductor device manufacturing. Processing tools can include a process chamber and one or more substrate support assemblies for single wafer processing or multi-wafer processing capabilities for batch processing. A substrate support assembly may include various components such as cooling gas lines, pusher pins, RF lines, heating electrodes, etc. Heating electrodes within substrate support assembly may be implemented to accelerate or enhance chemical reactivity to facilitate substrate processing. In least one implementation, process chamber may also be heated to provide uniform processing conditions for multiple wafer processing. Uniform processing conditions are useful to produce devices with substantially same characteristic across a semiconductor wafer.

Processing tools further include a gas delivery system and a showerhead coupled with gas delivery system. Here, “showerhead” may generally refer to a device that distributes a process gas within a process chamber. Here, “gas delivery system” may generally refer to a multi-component system of valves and pipes coupled with one or more gas sources utilized to control flow of gas to a process tool.

Process gases are introduced into processing chamber through exit holes in a showerhead. Here, “exit holes” may generally refer to holes within a portion of a showerhead that are designed for gases to escape into a pressured process chamber. In at least one implementation, exit holes can be arranged in different geometric patterns to facilitate varying levels of diffusion during a process. In at least one implementation, exit holes can be of different sizes, where an individual exit hole size may vary with location.

Because exit holes may be designed to enable gas to exit a showerhead and into a process chamber, it is useful to check for integrity of exit holes at various points in a life cycle of a showerhead. Typically, integrity of exit holes is checked during fabrication of a showerhead. In some implementations, a showerhead comprises a main body and a disk comprising exit holes that rests on main body. Here, “main body” may generally refer to majority component of showerhead. Here, “disk” may generally refer to a circular shaped object. In at least one implementation, disk may comprise quartz or aluminum and can be fabricated separately. In at least one implementation, exits holes can be drilled in a disk and then checked for integrity.

In at least one implementation, examination process may include placing disk on a light table that shines light at a substantially uniform magnification throughout a cross sectional area of disk. In least one implementation, disk can be manually examined, or a photographic plate or sheet can be placed in a path of light above disk that records light emanating from disk. Here, “photographic plate or sheet” may generally refer to a photosensitive object that can permanently record an image of light striking it. In at least one implementation, recorded image can be compared to location of exit holes to determine exit hole blockage.

In at least one implementation, exit holes in disk can be further checked for integrity after welding disk on to main body. In at least one implementation, showerhead includes a cavity within main body. In at least one implementation, cavity is capped by disk comprising exit holes. Here, “cavity” may generally refer to a void within a material. In at least one implementation, a void may be intentionally or unintentionally formed. In at least one implementation, showerhead includes at least one entrance hole, where a gas is fed through during operation. In at least one implementation, an entrance hole is typically in main body. In at least one implementation, entrance hole can be opposite to exit hole or be adjacent to it, depending on a gas delivery configuration. In at least one implementation, a light source is utilized to shine light into an entrance hole of showerhead. In at least one implementation, light can be deflected from inner surfaces within cavity and escape from exit holes. Here, “light source” may generally refer to a device that can generate light through electrical means, such as light bulbs, LEDs, etc. In at least one implementation, light escaping from exit holes can be recorded by a light recording device and analyzed for hole blockage. In at least one implementation, one or more holes can be completely or partially blocked. Here, “entrance hole” may generally refer to a hole within main body of showerhead where process gases are fed through. In at least one implementation, process gases can enter showerhead through one or more entrance holes. Here, “hole blockage” may generally refer to a phenomenon that results in blocking of holes that are designed to transmit heat, light or matter.

In at least one implementation, light source is part of a structure to provide illumination (herein illumination structure) and may include at least one light emitting diode. Here, “illumination structure” may generally refer to a structure that includes a light source and one or more components such as batteries, heat sinks, mechanical support etc. In at least one implementation, light emitting diode (LED) may be coupled with a light pipe to direct light in through entrance hole. In at least one implementation, light pipe can be inserted into entrance hole. Here, “light pipe” may generally refer to a structure comprising a material that is utilized to transmit light by internal reflection, where internal reflection can be total internal reflection or reflection off a reflective compound that may be applied to an external surface. In at least one implementation, LED is coupled with a conductive rod. In at least one such implementation, at least a portion of LED can be inserted into entrance hole.

In at least one implementation, cavity within showerhead may include a gas diffusion plate. Here, “gas diffusion plate” may generally refer to an object that is designed to diffuse gas entering cavity towards exit holes. In at least one implementation, gas diffusion plate can be implemented to enhance uniformity of gas distribution through showerhead. In at least one implementation, gas diffusion plate can be augmented by a diffuser attached to gas diffusion plate. In at least one implementation, diffuser can be utilized to mechanically bend illumination structures such as fiber optic wires. Here, “diffuser” may generally refer to a structure that is utilized to diffuse gas or light when gas or light impinges on a surface of diffuser.

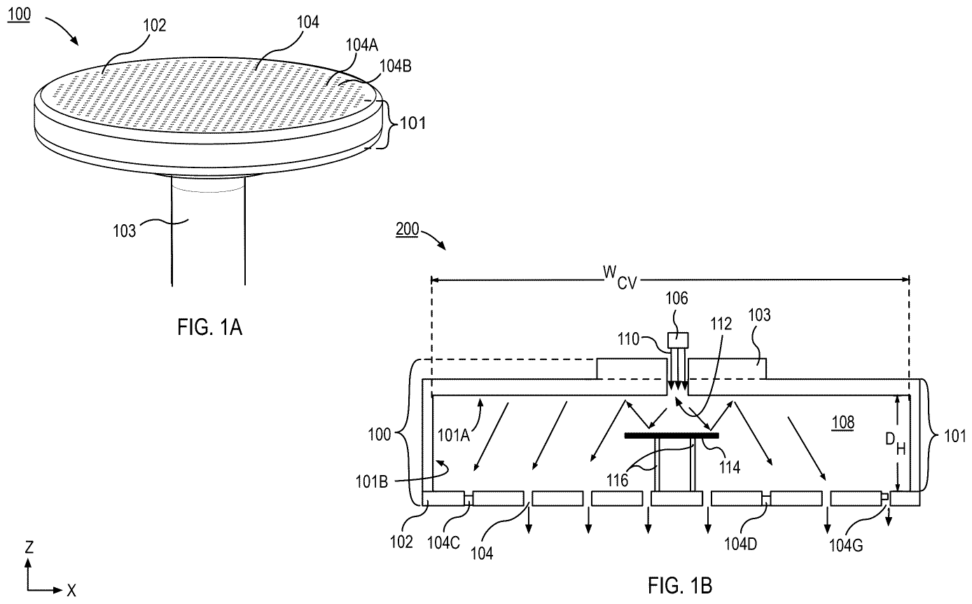

FIG. 1A is an isometric illustration of showerhead 100, in at least one implementation. In at least one implementation, showerhead 100 includes body 101, disk 102, stem 103, and exit holes 104 within disk 102. In at least one implementation, exit holes 104 can be arranged in different patterns. In at least one implementation, exit holes 104A, 104B etc. can be uniformly spaced apart. In at least one implementation, exit holes 104A, 104B etc. can have same or a substantially same size as will be discussed below. In at least one implementation, a same or substantially same size is useful for controlling distribution of gas that will flow through exit holes 104 during processing operation.

In at least one implementation, stem 103 comprises a hollow cylinder that provides a conduit for a gas distribution line to be inserted for operation. Here “disk” may generally refer to a circular shaped object with a cavity within. Here “stem” may generally refer to a columnar structure. In at least one implementation, columnar structure can be a tube.

In at least one implementation, exit holes 104 can be examined for defects such as partial or complete blockage by illuminating a cavity within showerhead 100 and collecting light emanating from exit holes 104. Methods to illuminate cavity and different structural implementations utilized will be discussed in detail below.

FIG. 1B illustrates a cross-section of showerhead 100 and illumination structure 106 directing light into cavity 108 within showerhead 100, in accordance with at least one implementation. In at least one implementation, illumination structure 106 can include an LED, where the LED is external to showerhead 100. In at least one implementation, illumination structure 106 includes a flashlight including a lightbulb. In at least one implementation, the light bulb can be a tungsten filament based incandescent lightbulb or an LED.

In at least one implementation, light 110 is produced externally to entrance hole 112, enters cavity 108, deflects from surfaces 101A and 101B of showerhead 100 and exits through exit holes 104. In at least one implementation, light 110 escaping from exit holes 104 can be recorded and examined for blockage, if any, in exit holes 104. As shown, some holes, such as exit holes 104C and 104D, may be blocked. In at least one implementation, exit holes 104C and 104D may include material of disk 102 or residue built up from processing. In at least one implementation, hole 104G may be partially blocked.

In at least one implementation, showerhead 100 further includes a gas diffusion plate, herein plate 114, that is coupled with disk 102. In at least one implementation, plate 114 is coupled with disk 102 by pins 116. In at least one implementation, plate 114 may have a surface area that covers at least entrance hole 112. In at least one implementation, plate 114 is utilized to diffuse gas, that enters through entrance hole 112, throughout cavity 108 during operation. In at least one implementation, plate 114 is used to diffuse light that enters through entrance hole 112 during examination of blockage of exit holes 104.

In at least one implementation, intensity of light 110 utilized to determine hole blockage can depend on a size of cavity 108, which in turn can depend on diameter of disk 102 and depth D_{H} of body 101. In at least one implementation, intensity of light utilized can depend on type of illumination structure implemented. Different implementations are described below.

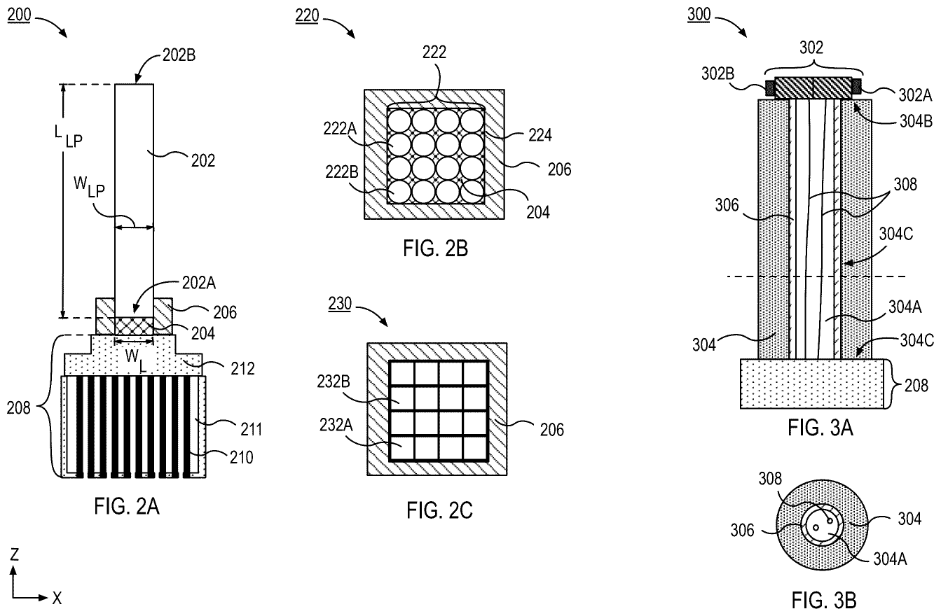

FIG. 2A illustrates a cross-section of illumination structure 200 comprising light pipe 202 coupled with light source 204, in accordance with at least one implementation. In at least one implementation, light pipe comprises an acrylic, a polycarbonate or a glass material that can transmit light along length of pipe. In at least one implementation, end 202A of light pipe is optically coupled with light source 204 and a second end 202B can have different surface features or shapes. In at least one implementation, shapes of end 202A of light pipe can be flat recessed or have protrusions. Different shapes of light pipe 202 will be described in detail below. As shown, in at least one implementation, end 202B is flat. Light pipe 202 has a width W_{LP} and light source has a width W_{L}. In at least one implementation, width W_{LP} can be at least as wide as width W_{L}, as shown. In at least one implementation, width W_{LP} can be greater than width W_{L}, to capture all light that can emanate from light source 204 during operation. In at least one implementation, light pipe 202 has a length L_{LP}, that can vary with application as will be discussed below.

In at least one implementation, light pipe 202 is also coupled with a support column 206. Here, “support column” may generally refer to a structure utilized to provide mechanical stability. In at least one implementation, support column 206 laterally surrounds light pipe 202 and extends a portion of length of light pipe 202. In at least one implementation, support column 206 includes a material that can be conductive or insulative. In at least one implementation, insulative material includes ceramics, plastic, and/or fiberglass.

In at least one implementation, light source 204 includes a light emitting diode (LED). In at least one implementation, LED may operate at a power range of at least 3 Watts. In at least one implementation, LED operating at least 3 Watts may generate heat during operation. Heat generated during operation may damage LED reducing its operational life span. In at least one implementation, heat generated from LED can be absorbed and radiated away by a heat sink 208. Here, “heat sink” may generally refer to a conductive object that is designed to absorb heat from warmer conductive material that it is in physical contact with. In at least one implementation, heat sink 208 includes one or more conductive rods and/or walls 210, where any two rods and/or walls 210 are separated by gap 211. In at least one implementation, a cap structure 212 is coupled between light source 204 and heat sink 208. In at least one implementation, cap structure 212 can be utilized to divert heat from light source 204 to heat sink 208. In at least one implementation, cap structure 212 can include a conductive material. In at least one implementation, external surfaces of cap structure 212 can be coated with an insulative compound.

In at least one implementation, light pipe 202 can be a cylinder. In at least one implementation, light pipe 202 can be rectangular. In at least one implementation, light pipe 202 is conical. In at least one implementation, light pipe 202 can be frustoconical, where a top portion is wider than a bottom portion or vice versa.

While one light pipe 202 has been illustrated in FIG. 2A, in at least one implementation, illumination structure 200 can include multiple light pipes. FIG. 2B is a plan view illustration of a light pipe structure 220. Here, “light pipe structure” may generally refer to a structure comprising a plurality of light pipes arranged in a manner to collectively enable transmission of light. In at least one implementation, light pipe structure 220 includes a collection of light pipes 222 within an enclosure 224.

In at least one implementation, collection of light pipes 222 includes individual light pipes 222A, 222B etc. that have one or more properties of light pipe 202 (FIG. 2A). In at least one implementation, individual light pipes 222A, 222B etc. can be cylindrical. In at least one implementation, collection of light pipes 222 covers or substantially covers light source 204.

In at least one implementation, as shown in plan view illustration of in FIG. 2C, light pipe structure 230 can include individual light pipes 232A, 232B etc. that are rectangular. In at least one implementation, a rectangular shape can be more useful to transmit substantial portion of light emanating from light source 204. In at least one implementation, individual light pipes 232A, 232B etc. have one or more properties of light pipe 202 (FIG. 2A). In at least one implementation, collectively in FIGS. 2B and 2C, support column 206 may be rectangular. In at least one implementation, support column 206 can be circular, oval, or elliptical.

In at least one implementation, a light source can be positioned at a top portion of an illumination structure. In at least one implementation, illumination structure can include at least one light source that can be an LED.

Referring again to FIG. 2A, in at least one implementation, heat sink structure 208 and light source 204 can be replaced by a flashlight structure, where the flashlight includes light source 204 which can be an LED or an incandescent bulb. In some such implementations, flashlight can be optically coupled to light pipe 202.

FIG. 3A illustrates a cross-section of illumination structure 300, in accordance with at least one implementation. In at least one implementation, illumination structure 300 comprises at least one light source 302 and rod 304, where light source 302 may at least partially cover end 304B. Here, “rod” may generally refer to an object having a longitudinal structure. In at least one implementation, rod 304 includes hole 304A that extends along a longitudinal direction of rod 304, as shown. In at least one implementation, rod 304 can be open at ends 304B and 304C. In at least one implementation, hole 304A at end 304B can be at least partially covered by light source 302. In at least one implementation, rod 304 has a shape that can be cylindrical, rectangular, or any other regular or irregular shape. In at least one implementation, plan view cross section of rod 304 can be triangular. In at least one implementation, rod 304 comprises of a thermally conductive material such as aluminum, stainless steel etc.

In at least one implementation, light source 302 includes two LEDs, such as LEDs 302A and 302B, coupled with rod 304, as illustrated. In at least one implementation, rod 304 can be utilized to conduct and transfer heat from LEDs 302A and 302B to heat sink 208 that is coupled with rod 304.

In at least one implementation, illumination structure 300 further includes thermal insulator 306 within hole 304A. Here, “thermal insulator” may generally refer to a structure that is designed to protect one or more components adjacent to it from damaging heat conduction by providing a physical barrier. In at least one implementation, thermal insulator 306 can be implemented to shield wires 308 connected with LEDs 302A and 302B from rod 304. In at least one implementation, thermal insulator 306 can be directly adjacent to and in contact with wall 304D of rod 304, as shown and may laterally surround wires 308. In at least one implementation, thermal insulator 306 may not be in contact with wall 304D of rod 304. In at least one implementation, thermal insulator 306 comprises ceramic or a high temperature resistant plastic. In at least one implementation, a high temperature resistant plastic can be resistant to temperatures that are less than 250 degrees Celsius.

In at least one implementation, LEDs 302A and 302B can be arranged in a manner to cover hole 304A. In at least one implementation, light source 302 covers hole 304A. In at least one implementation, wires 308 can be coupled with an electrical circuit that is external to heat sink 208 and rod 304.

FIG. 3B is a plan view illustration through a line A-A′ of structure in FIG. 3A, in accordance with at least one implementation. In at least one implementation, rod 304 can have a circular cross section and hole 304A is also circular. In at least one implementation, thermal insulator 306 can also have a circular profile, as shown. In at least one implementation, rod 304 and thermal insulator 306 can have different plan view shapes.

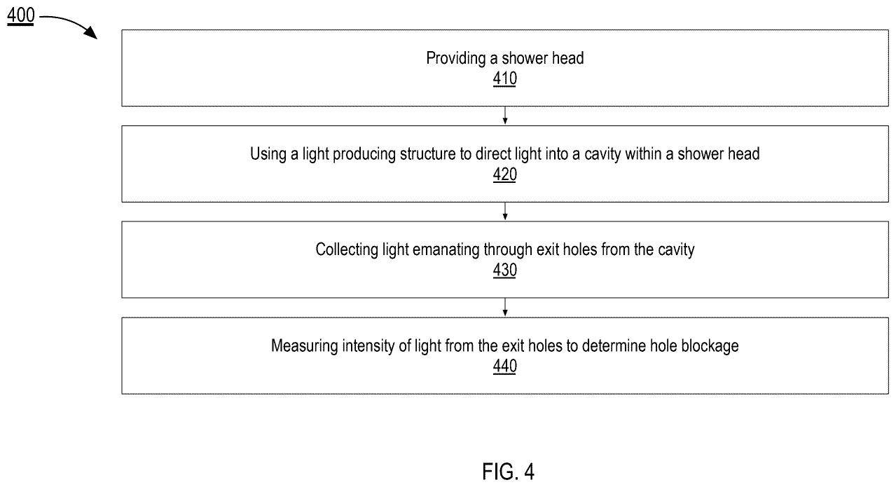

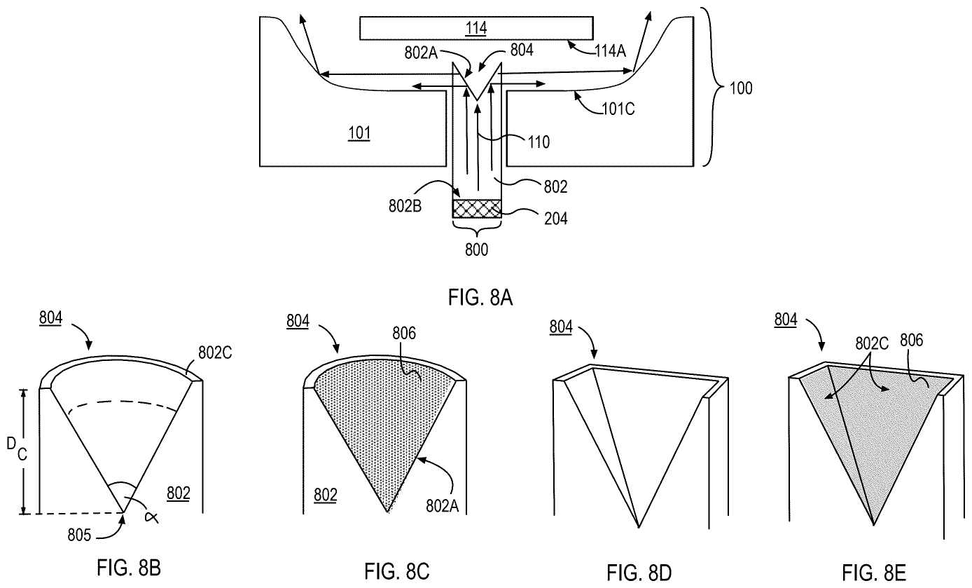

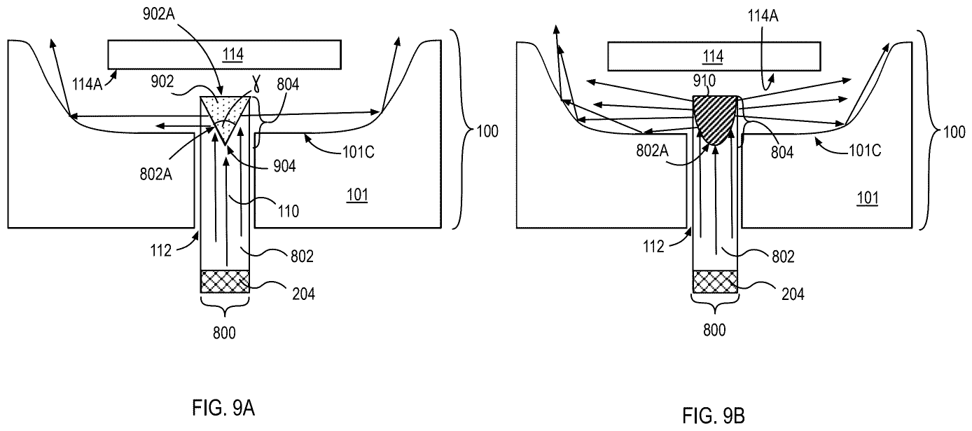

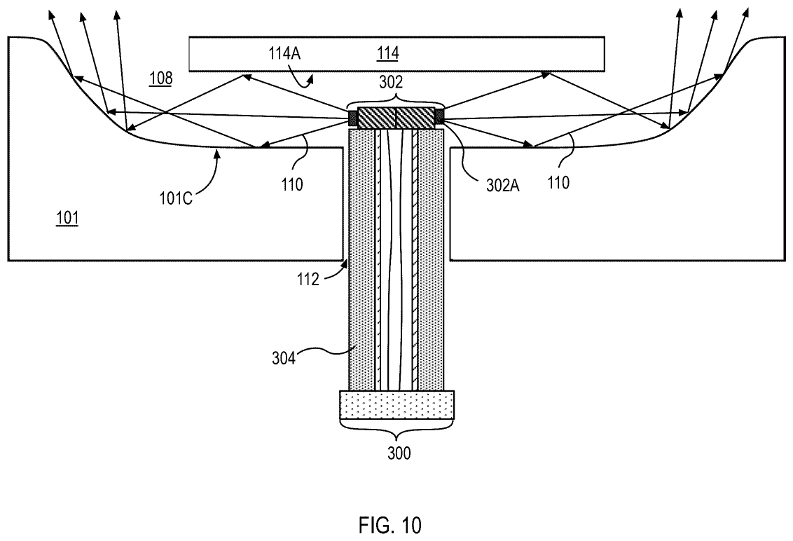

FIG. 4 illustrates a flow diagram of a method 400 to measure hole blockage, in accordance with at least one implementation. Method 400 begins at operation 410 by providing a showerhead, such as showerhead 100 (FIGS. 1A-1B). Method 400 continues at operation 420 with process to use an illumination structure to direct light into a cavity within a showerhead. In different implementations, illumination structure can include at least one of the illumination structures illustrated in FIGS. 2A-2C or FIGS. 3A-3B as will be discussed below in FIGS. 8A-9B, and in FIGS. 9A-9B and in FIG. 10. In different implementations, illumination structures include at least one light source. In at least one implementation, positions of an individual light source within different illumination structures can be varied within the showerhead during the process to direct light into the cavity. In at least one implementation, light source can be extended into the cavity itself. In at least one implementation, when light source is inserted to different extents within cavity, showerhead can be illuminated differently.

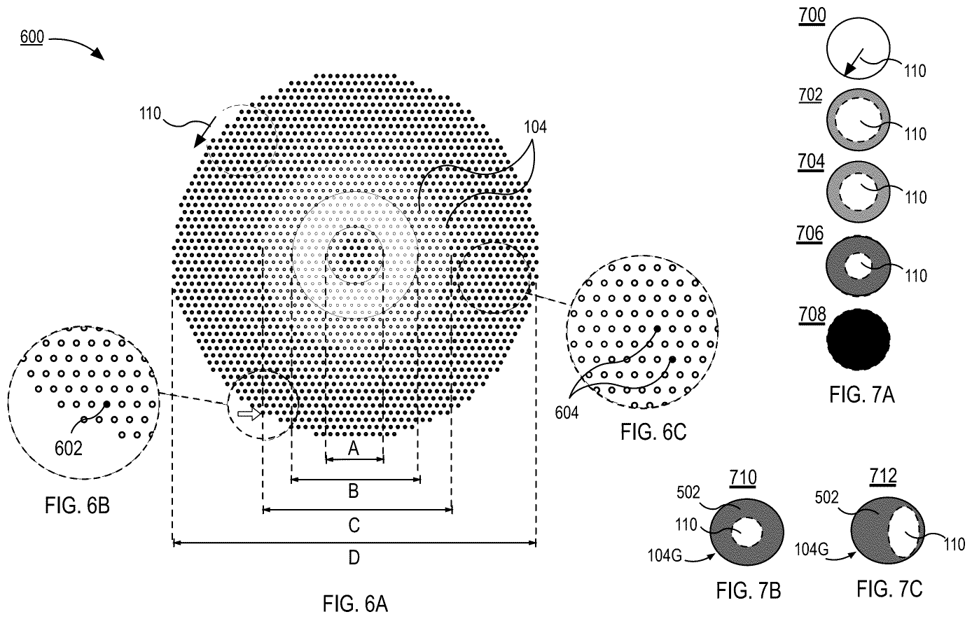

Depending on the type of illumination structure implemented, different regions of the showerhead can be examined. In at least one implementation, the same illumination structure can be used with different light intensities. In at least one implementation, using different light intensities can be useful to increase illumination in otherwise poorly illuminated portions of the showerhead, as will be discussed in FIG. 6A.

Method 400 continues at operation 430 by collecting light emanating through exit holes from the cavity. In at least one implementation, light can be collected by using an apparatus, such as a digital camera or using a photographic plate.

Method 400 may end at operation 440 by measuring intensity of light from exit holes to determine hole blockage. In at least one implementation, light intensity from various locations can be analyzed to determine which holes if any are blocked. In at least one implementation, one or more machine algorithms may be used that compares light exiting from at least three neighboring holes to determine if a hole is blocked, and an extent to which the hole is blocked. In at least one implementation, holes may be partially blocked. In cases where the hole is partially blocked, one or more machine algorithms may perform additional operations to determine whether partial blockage is due to reduced intensity of light itself or an actual blockage.

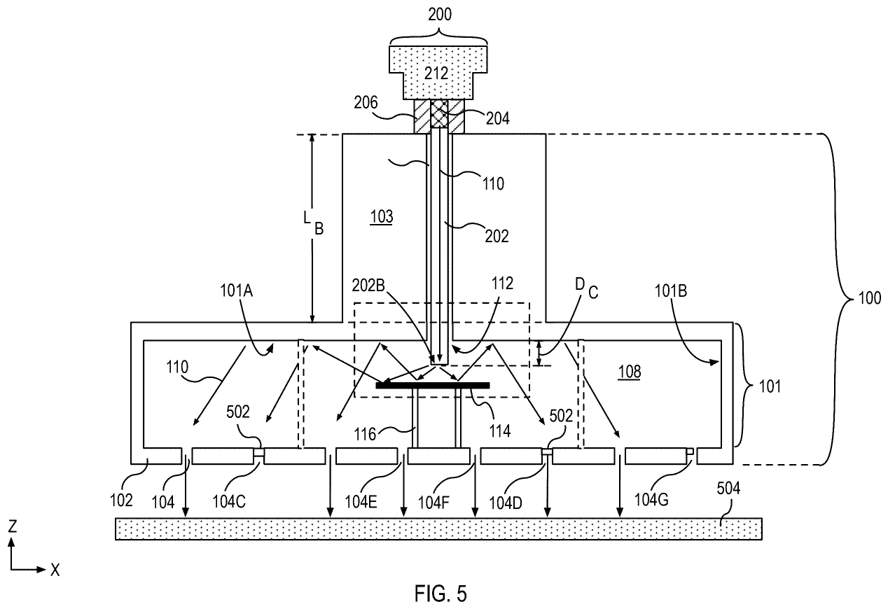

FIG. 5 illustrates a cross-section of utilization of illumination structure 200 depicted in FIG. 2A to measure blockage in exit holes 104 in showerhead 100, in accordance with at least one implementation. In at least one implementation, light pipe 202 is configured to extend into entrance hole 112 of showerhead 100. In at least one implementation, entrance hole 112 extends along a length L_{S} of stem 103. In at least one implementation, light pipe extends along an entire length L_{S}, and protrudes into cavity 108 beyond surface 101A. In at least one implementation, light pipe 202 extends a distance D_{C} beyond surface 101A. In at least one implementation, extent to which light pipe extends into cavity 108 can be controlled by adjusting length of light pipe 202 and by inserting a spacer between support column 206 and stem 103. In at least one implementation, distance D_{C} can change illumination of light exiting through cavity 108. In at least one implementation, D_{C} can be at least 1 mm.

In at least one implementation, after insertion of light pipe into entrance hole 112, light source 204 can be turned on and light 110 travels along length of light pipe 202 and exits from end 202B into cavity 108. In at least one implementation, end 202B can be substantially planar. In at least one implementation, light 110 escapes from end 202B and strikes plate 114 prior to reflecting from surfaces 101A and reaching exit holes 104. In at least one implementation, light 110 escapes from end 202B and strikes plate 114 and can be deflected from surfaces 101A and 101B before exiting from exit holes 104.

In at least one implementation, light 110 can reach all (or substantially all) exit holes 104 within cavity 108, light 110 emanating from exit holes 104 that are distributed along different portions of cavity can have different levels of intensity. Varying levels of light intensity can be a result of reduction in intensity in light 110 as light 110 travels from end 202B of light pipe towards exit holes 104. In at least one implementation, depending on where light 110 strikes plate 114, light can undergo multiple reflections before reaching exit holes 104. In at least one implementation, light intensity across exit holes 104 can vary depending on loss during each reflection. In at least one implementation, intensity of light emanating from holes near surface 101B is lower than intensity of light emanating from edge of plate 114. While, light 110 emanating from exit holes 104 can have different levels of intensity, light 110 reaching exit holes 104C and 104D may not escape due to blockage from debris 502. Here, “debris” may generally refer to an object that may not have fundamental usefulness. Debris 502 may comprise metallic material that is same or substantially same as material of disk 102 or may be material that has accumulated over usage of showerhead 100. Presence of debris 502 can present functionality issues. In at least one implementation, exit holes 104E and 104F are examples of unblocked exit holes 104. In at least one implementation, showerhead 100 can also include holes that are partially blocked, such as hole 104G. Light 110 may exit from a partially blocked hole and the intensity of light 110 may be less than intensity of light at a neighboring hole.

In at least one implementation, a light collecting apparatus 504 can be placed directly below disk 102 in path of light 110 that exits from exit holes 104. Here, “light collecting apparatus” may generally refer to an object that is capable of recording light impinging on it. In at least one implementation, light collecting apparatus 504 includes a photographic plate or a camera. In at least one implementation, photographic plate may contain a light sensitive film that can record photons comprising light 110. An image collected by light collecting apparatus 504 will be described below.

FIGS. 6A-C and 7A illustrate recording 600 of light 110 exiting through exit holes 104 in showerhead 100 (FIG. 5), in accordance with at least one implementation. In at least one implementation, light collecting apparatus 504, such as a photographic plate, can be utilized to obtain recording 600 illustrated in FIG. 6A. In at least one implementation, light 110 emanating from exit holes 104 can have different levels of intensity, depending on a distance from center of disk 102 (FIG. 5). In at least one implementation, light 110 emanating from exit holes 104 can have different levels of intensity, depending on a distance from center of disk 102 for a same size of exit holes 104 in disk 102 (FIG. 5). In at least one implementation, different light intensities can vary radially from an edge of plate (for example, plate 114 in FIG. 5).

In at least one implementation, there are at least five distinct levels of light 110 represented in recording 600. In at least one implementation, four distinct levels of light 110 are represented by different bands in recording 600. Here, “bands” may generally refer to regions that are characterized by structures having similarity in mechanical or chemical properties. Different levels of light 110 are illustrated in FIG. 7A, in accordance with at least one implementation. In at least one implementation, recording 700 is an illustration of a highest level of intensity of light and corelates with light 110 within band B in FIG. 6A. In at least one implementation, recording 702 is an illustration of a level of intensity of light 110 that is partially dim compared to intensity of light in recording 700, and corelates with light 110 within band C in FIG. 6A. In at least one implementation, recording 704 is an illustration of a level of intensity of light 110 that is lower compared to intensity of light 110 in recording 702, and corelates with light 110 within bands A and D, in FIG. 6A. In at least one implementation, recording 706 is an illustration of a level of intensity of light 110 that is lower compared to intensity of light 110 in recording 704, and corelates with light 110 in an outer edge of band D in FIG. 6A. In at least one implementation, in addition to variation in light intensity with radius, blocked holes can be located randomly. In at least one implementation, recording 708 is an illustration of a blocked hole and corelates with blockages represented by locations 602 and 604 in enhanced illustrations in FIGS. 6B and 6C, respectively. In at least one implementation, locations 602 and 604 can be randomly positioned within recording 600.

In at least one implementation, an automated program can be implemented to determine which holes are blocked. In at least one implementation, an automated program can compare intensity of light 110 of at least two nearest neighbors relative to a sample location in recording 600 and determine if there is a blockage. In at least one implementation, an automation program can be utilized to scan all sample locations in recording 600.

While recordings 702-706 have been used to describe varying levels of intensity of light 110 due to proximity of light source from location of holes in showerhead, differences in intensity of light can also be caused by varying levels of blockage of holes 104. In at least one implementation, a partially blocked hole (such as hole 104G in FIG. 5) can produce a recording that is defined by any one of recordings 702-706.

FIGS. 7B and 7C illustrate recording 710 and 712 of light 110 exiting through exit holes 104G in showerhead 100 (FIG. 5). In at least one implementation, light 110 from a partially blocked hole 104G may emanate from center of hole 104G as shown in FIG. 7B, or from an edge as shown in FIG. 7C. Depending on implementation, debris 502 can be of different shapes, and cover different parts of hole 104G as shown. In at least one implementation, a partially blocked hole 104G can transmit light 110 of a different color than light from a neighboring hole due to diffraction of light 110 as it traverses partially blocked hole 104G. In at least one implementation, color of light can also be influenced by nature of debris 502.

Referring collectively to FIGS. 5 and 6, in at least one implementation, intensity of light 110 can be varied to enable detection of light 110 at different locations relative to a center of disk 102. In at least one implementation, method of determining blockage can include utilizing illumination structure 200 to produce light 110 of a first intensity and measuring a first spread of intensities of light 110 emanating from exit holes 104. In at least one implementation, first intensity can be lower than intensity of light utilized to produce recording 600. In at least one implementation, it can be useful to lower intensity of light 110 to prevent high levels of illumination within band B. High levels of illumination may introduce light pollution and make it difficult to measure blockages in holes within band B. In at least one implementation, with first intensity of light 110, an automated program (discussed above) can be implemented to determine if there are blocked holes, at least within band B. In at least one implementation, with a lowered intensity of light 110, recordings outside of band B can be represented by substantially blocked or blocked holes, such as those represented by recording 706 and 708, respectively (FIG. 7).

In at least one implementation, method of determining blockage in disk 102 can be further continued by producing light 110 of a second intensity. In at least one implementation, second intensity is at least 10% greater than first intensity. In at least one implementation, by changing intensity of light 110, a second spread of intensities of light 110 emanating from exit holes 104 can be measured. In at least one implementation, second spread of intensities may produce a recording where band B can be over exposed, but bands C and D may have increased illumination. In at least one implementation, increase in illumination at radii away from band B can be useful to determine hole blockage more accurately. In at least one implementation, first spread of intensity of light 110 and second spread of intensity of light 110 can be compared to determine hole blockage over all radii in disk 102.

In at least one implementation, method of determining blockages in exit holes 104 may include making multiple recordings and examining different bands to obtain a full understanding of blockages in exit holes 104. In at least one implementation, method may also include changing configuration, including structural design, of illumination structure 200, and how it is implemented to vary illumination of cavity 108. Other changes can include making modifications to surfaces 101A and 101B to promote reduction in variation in light intensity while providing for uniform gas distribution out of showerhead 100. In at least one implementation, portions of surfaces 101A and 101B can be differentially polished or coated to vary illumination within cavity 108.

FIG. 8A is an enhanced cross-sectional illustration of showerhead 100, where illumination structure 800 comprising light pipe 802 is inserted into entrance hole 112 to provide light 110 in cavity 108, in accordance with at least one implementation. In at least one implementation, cavity 108 within body 101 has surfaces that are non-planar. In at least one implementation, surface 101C of body 101 is curved. In at least one implementation, surface 101C, that is curved, can be useful in promoting gas distribution within showerhead 100. In at least one implementation, surface 101C may also deflect light 110 differently from planar surfaces such as surfaces 101A and 101B (FIG. 5). In at least one implementation, light pipe 802 includes one or more properties of light pipe 202 (FIG. 5). In at least one implementation, light pipe 802 comprises a recess 804. In at least one implementation, recess 804 forms surface 802A in light pipe 802, opposite to end 802B coupled with light source 204. In at least one implementation, recess 804 can be cone shaped or conical. A cross-sectional portion of cone-shaped recess 804 is illustrated in the isometric illustration of FIG. 8B. The cross section may be taken along a mid-plane of recess 804. In such implementations, recess 804 has an apex angle, alpha (α), where α is between 10 degrees and 120 degrees. Apex angle alpha α is inversely proportional to a depth D_{C} of recess 804, where the depth Dc is the distance between the uppermost surface 802C and the apex 805. For instance, the apex angle α increases as the depth Dc decreases and the apex angle α decreases as the depth Dc increases. In at least one implementation, surface 802C at top of recess 804 can have a planar portion as shown. In at least one implementation, some light can leak from surface 802C and reach surface 114A (FIG. 8A).

In at least one implementation, to further promote improved reflection of light, surface 802A of light pipe 802 may be coated with reflective material 806, as shown in a cross-sectional portion of cone-shaped recess 804 illustrated in FIG. 8C. In at least one implementation, reflective material 806 can include layers of gold, aluminum, or silver.

In at least one implementation, recess 804 can be pyramid shaped, as shown in a cross-sectional portion of cone-shaped recess 804 as shown in a cross-sectional portion of cone-shaped recess 804 illustrated in FIG. 8D. In at least one implementation, surfaces 802C of light pipe 802 can be coated with reflective material 806 as shown in a cross-sectional portion of cone-shaped recess 804 illustrated in FIG. 8E.

Referring collectively to FIGS. 8A-D, in at least one implementation, recess 804 that can be cone or pyramid shaped can be useful to promote reflection of light towards surface 101C. In at least one implementation, position of end of light pipe 802 can be controlled to change deflection angle of light 110 from surface 101C. In at least one implementation, end of light pipe 802 is at least 1 mm away from surface 114A of plate 114. In at least one implementation, distance between light pipe 802 and plate 114 can be changed after turning on light source 204.

In at least one implementation, after turning on light source 204, light 110 can travel through light pipe 802 and reflect off surface 802A or 802C. In at least one implementation, light 110 can be directed towards surface 101C with less reliance on reflection from plate 114. In at least one implementation, directing light 110 towards surface 101C can reduce loss of intensity of light 110 arriving at holes in showerhead 100.

In at least one implementation, where light pipe 802 includes recess 804, light pipe 802 can be coupled with a structure that is inserted into recess 804 to provide deflection of light 110, instead of coating surface 802A or 802C.

FIG. 9A is an enhanced cross-sectional illustration of showerhead 100, where illumination structure 800 comprising light pipe 802 that is coupled with reflective structure 900 is inserted into entrance hole 112 to provide light 110 in cavity 108, in accordance with at least one implementation. Stem 103 is not illustrated in FIG. 9A for clarity. In at least one implementation, where stem 103 is included in design of showerhead 100, light source 204 is external to stem 103 (as illustrated in FIG. 5). In at least one implementation, showerhead 100 does not include stem 103.

In at least one implementation, reflective structure 900 includes a material which is optically reflective and has a low coefficient of light absorption. In at least one implementation, reflective structure 900 may include polished aluminum, stainless steel or other metallic material. In at least one implementation, reflective structure 900 is situated within recess 804. In at least one implementation, reflective structure 900 has a shape and size that matches shape and size of cone shaped recess 804. In at least one implementation, surfaces of reflective structure 900 are in contact with surface 802A. In at least one embodiment, reflective structure has an apex angle gamma (γ), where apex angle gamma is between 10 degrees and 120 degrees. Apex angle gamma is related to a depth or height of reflective structure 900 relative to surface 902A. Apex angle γ is inversely proportional to a depth or height of reflective structure 900, where the depth or height is the distance between the uppermost surface 902A and the apex 904. For instance, the apex angle γ increases as the depth or height of reflective structure 900 decreases, and the apex angle γ decreases as the depth or height of reflective structure 900 increases. In at least one embodiment, apex angle γ is substantially matched with apex angle α of recess 804 (FIG. 8B).

In at least one implementation, when light source 204 is turned on, light 110 is produced and travels along a length of light pipe 802 towards surface 802A. In at least one implementation, light 110 is deflected from surface of reflective structure 900 towards surface 101C of showerhead 100. Different trajectories of light 110 are illustrated in FIG. 9A. In at least one implementation, some of light 110 is also reflected from surface 114A.

In at least one implementation, light pipe 802 is coupled with a pyramidal structure inserted into a pyramidal shaped recess (FIG. 8D). In at least one implementation, reflective structure 900 has a shape and size that matches shape and size of pyramidal shaped recess 804.

FIG. 9B is an enhanced cross-sectional illustration of showerhead 100, where light pipe 802 that is coupled with reflective structure 910 is inserted into entrance hole 112 to provide light 110 in cavity 108, in accordance with at least one implementation.

In at least one implementation, reflective structure 910 includes a material that can be optically reflective and has a low coefficient of light absorption. In at least one implementation, reflective structure 910 may include polished aluminum, stainless steel or other metallic material. In at least one implementation, reflective structure 910 has a shape and size that matches shape and size of parabolic shaped recess 804. In at least one implementation, surfaces of reflective structure 900 are in contact with surface 802A. In at least one implementation, recess 804 can be spherical.

In at least one implementation, when light source 204 is turned on, light 110 can be produced and travels along a length of light pipe 802 towards surface 802A. In at least one implementation, light 110 can be deflected from surface of reflective structure 910 towards surface 101C of showerhead 100. In at least one implementation, some of light 110 can also be reflected from surface 114A after reflecting off surface of parabolic shaped reflective structure 910. Different trajectories of light 110 are illustrated in FIG. 9B. In at least one implementation, to change distribution of light exiting showerhead 100, focal point of parabolic shaped reflective structure 910 can be changed. In at least one implementation, distance between parabolic shaped reflective structure 910 and surface 114A can be changed.

FIG. 10 is an enhanced cross-sectional illustration of showerhead 100, where illumination structure 300 comprising light source 302 is configured to extend at least partially into entrance hole 112 to provide light 110 in cavity 108, in accordance with at least one implementation.

In at least one implementation, light source 302 can be extended into cavity 108. In at least one implementation, light source 302 includes two LEDs 302A and 302B. In at least one implementation, LEDs 302A and 302B are oppositely directed. In at least one implementation, when LEDs 302A and 302B are turned on, light 110 can be axially directed away from rod 304 can strike surfaces 101C and 112A and be reflected towards exit holes (above plate 114) in showerhead 100. In at least one implementation, LEDs 302A and 302B are at least 1 mm away from surface 112A. In at least one implementation, LEDs 302A and 302B are at least 1 mm away from surface 101C above entrance hole 112.

In at least one implementation, light source 302 is at least 1 mm away from surface 114A. In at least one implementation, light source 302 is at least 1 mm away from surface 101C. In at least one implementation, illumination structure 300 can be raised or lowered relative to surface 101C. In at least one implementation, raising and lowering illumination structure 300 can change intensity of light across exit holes above plate 114.

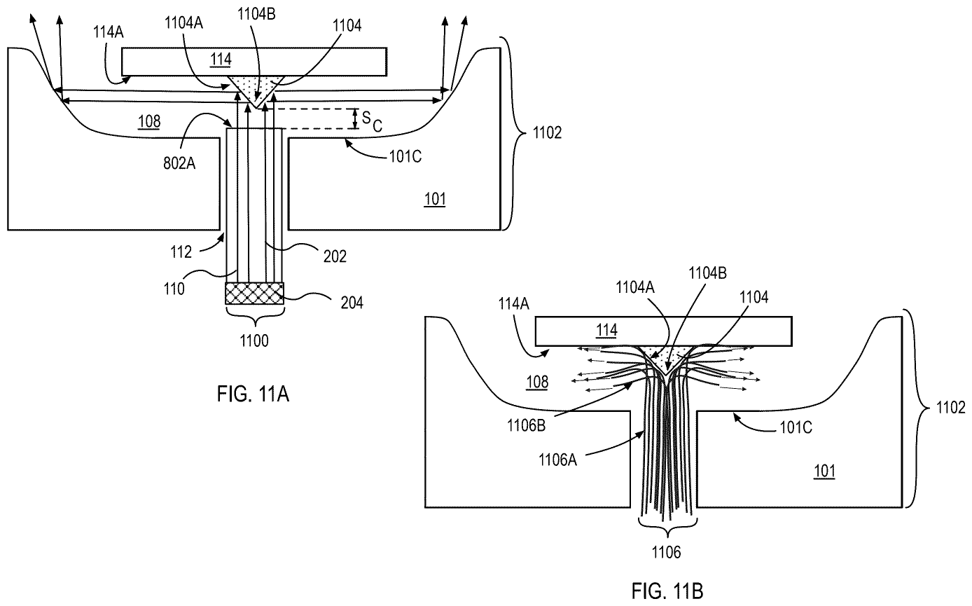

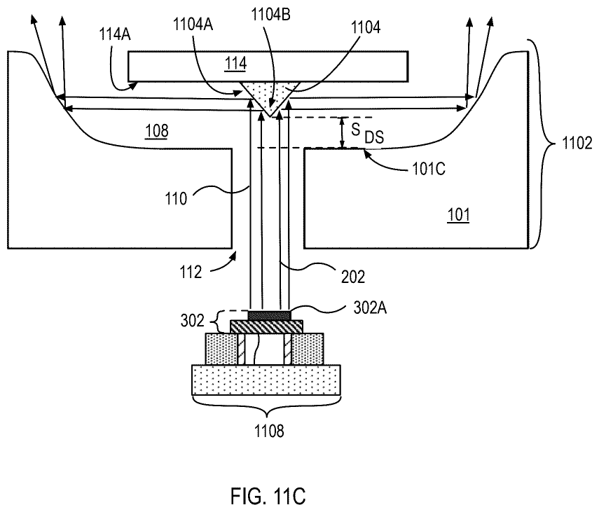

FIG. 11A is an enhanced cross-sectional illustration of an implementation of illumination structure 1100 inserted into showerhead 1102, where showerhead 1102 includes deflector 1104, in accordance with at least one implementation.

In at least one implementation, illumination structure 1100 has one or more features of illumination structure 200 (FIG. 2), such as light source 204 and light pipe 202. In at least one implementation, showerhead 1102 has one or more features of showerhead 100 (FIG. 8A), such as body 101, plate 114, cavity 108 and surface 101C that is curved. In at least one implementation, showerhead 1102 further comprises deflector 1104 that is coupled with plate 114. Here, “deflector” may generally refer to a structure that is designed to deflect material such as light, heat or particles impinging to change its trajectory. In at least one implementation, deflector 1104 and plate 114 are a single component. In at least one implementation, deflector 1104 can be coupled with plate 114 during a fabrication process. In at least one implementation, deflector 1104 can include the same material as material of plate 114 such as aluminum or stainless steel. In at least one implementation, surface 1104A of deflector 1104 can be polished to provide adequate reflectivity of light 110. In at least one implementation, deflector 1104 comprises a cone or a pyramid structure, where apex of cone or pyramid structure faces entrance hole 112. In at least one implementation, apex 1104B of deflector 1104 can be separated from entrance hole 112 by a distance S_{C}. In at least one implementation, distance S_{C} can be at least 1 mm.

As shown in FIG. 11A, in at least one implementation, when light source 204 is turned on, light 110 can be directed in cavity after traversing light pipe 202 and deflected by deflector 1104 into different directions. In at least one implementation, light 110 can be directed into surface 101C and reflects from surface 101C towards exit holes above plate 114. In at least one implementation, light 110 can be reflected towards surface 114A of plate and reaches exit holes after reflecting off surface 101C. In at least one implementation, depending on where light 110 strikes deflector 1104 light can undergo multiple reflections before reaching exit holes. In at least one implementation, light intensity across exit holes in showerhead 1102 can vary depending on loss during each reflection. In at least one implementation, light 110 exiting from showerhead 1102 can be recorded in a manner described above and analyzed for hole blockage.

FIG. 11B is an enhanced cross-sectional illustration of an implementation of an illumination structure 1106 directing light into showerhead 1102, where showerhead 1102 includes deflector 1104, in accordance with at least one implementation. In at least one implementation, illumination structure 1106 includes a plurality of fiber optic cables 1106A, 1106B etc.

In at least one implementation, to measure hole blockage in showerhead 1102, illumination structure 1106 can be inserted into cavity 108 through entrance hole 112. In at least one implementation, inserting illumination structure 1106 further comprises bringing plurality of fiber optic cables 1106A, 1106B etc. into contact with deflector 1104. In at least one implementation, deflector 1104 comprises a cone or a pyramid structure, where apex of cone or pyramid structure faces entrance hole 112. Apex 1104B of deflector 1104 is separated from entrance hole 112 by a distance S_{C}. In at least one implementation, distance S_{C} can be at least 1 mm.

In at least one implementation, after turning on illumination structure 1106, light 110 is directed towards surfaces 101C and 114A. In at least one implementation, light 110 reflects from surfaces 101C and 114A towards exit holes above plate 114. In at least one implementation, light 110 exiting from showerhead 1102 can be recorded in a manner described above and analyzed for hole blockage.

FIG. 11C is an enhanced cross-sectional illustration of an implementation of an illumination structure 1108 directing light into a showerhead 1102, where showerhead 1102 includes deflector 1104, in accordance with at least one implementation. In at least one implementation, apex 1104B of deflector 1104 is separated from entrance hole 112 by a distance S_{C}. In at least one implementation, distance S_{C} can be at least 1 mm.

In at least one implementation, illumination structure 1108 includes a light source 302. In at least one implementation, the light source includes LED 302A, where LED 302A is external to showerhead 1102. In at least one implementation, light source 302 includes a flashlight including a light bulb. In at least one implementation, light bulb can be a tungsten filament based incandescent light bulb or an LED. In at least one implementation, method of determining hole blockage includes turning on LED 302A and directing light towards deflector 1104 and reflecting light 110 from surface 101C, and/or surface 114A to direct light 110 towards exit holes above plate 114. In at least one implementation, light 110 exiting from showerhead 1102 can be recorded in a manner described above and analyzed for hole blockage.

Different illumination structures described herein may be mounted to showerhead by different mechanisms to produce stable recordings at a recording plate. In some implementations, showerhead, light source and recording plates can be housed inside an opaque enclosure to increase accuracy of measurement.

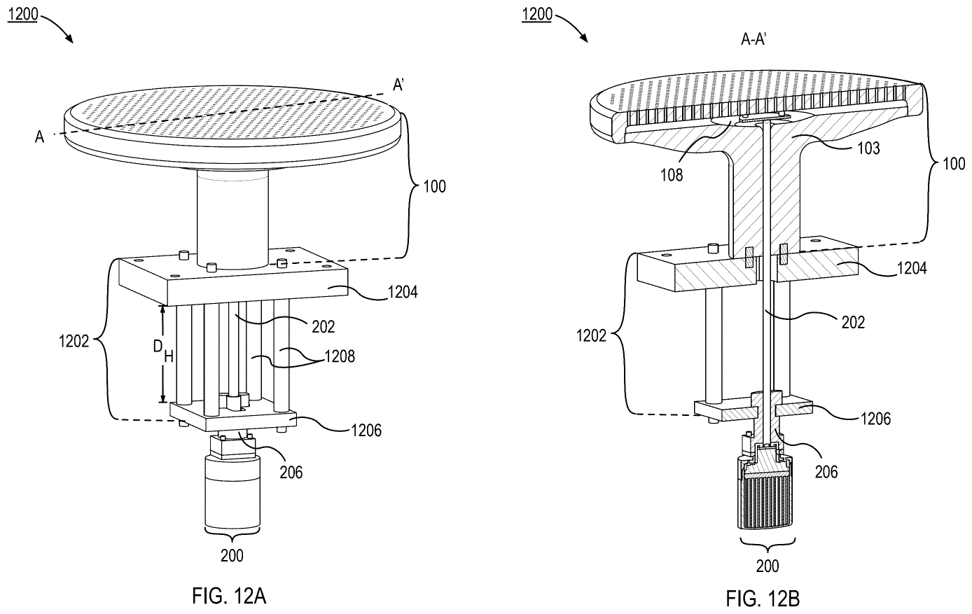

FIG. 12A is an isometric illustration of apparatus 1200, in accordance with at least one implementation. In at least one implementation, apparatus 1200 includes illumination structure 200 coupled with showerhead 100 by mounting structure 1202.

In at least one implementation, mounting structure 1202 includes upper plate 1204 that can be coupled with stem 103 of showerhead 100, and lower plate 1206 that may be coupled with support column 206. In at least one implementation, lower plate 1206 and upper plate 1204 can be mechanically coupled together by bolts 1208, as shown. In at least one implementation, lower plate 1206 and upper plate 1204 can be separated by a distance that can be dependent on length of light pipe 202. In at least one implementation, apparatus 1200 can be housed inside an opaque enclosure to increase accuracy of measurement of hole blockage. Here, “opaque enclosure” may generally refer to a structure that is designed to block external light.

FIG. 12B is an isometric illustration through a mid-plane of structure in FIG. 12A, in accordance with at least one implementation. In at least one implementation, light pipe 202 is in contact with support column 206 and extends into cavity 108 of showerhead 100.

The following are additional examples provided in view of the above-described implementations. Here, one or more features of an example, in isolation or in combination, can be combined with one or more features of one or more other examples to form further examples also falling within the scope of the disclosure. As such, at least one implementation can be combined with at least another implementation without changing the scope of the disclosure.

Besides what is described herein, various modifications may be made to disclosed implementations without departing from their scope. Therefore, illustrations of implementations herein should be construed as examples, and not restrictive to scope of present disclosure.

Example 1 is an illumination structure comprising: a light source; and a light pipe comprising a light transmitting material, a first end, and a second end, wherein the first end of the light pipe is configured to couple to the light source and the second end is configured to extend at least partially into a showerhead.

Example 2 is the illumination structure of any example herein, particularly example 1, wherein the light source is a light emitting diode.

Example 3 is the illumination structure of any example herein, particularly example 1, wherein the light pipe is a cylindrical structure, a conical structure, a frustoconical structure, or a rectangular structure.

Example 4 is the illumination structure of any example herein, particularly example 1, wherein the second end comprises a cone-shaped recess.

Example 5 is the illumination structure of any example herein, particularly example 4, wherein the cone shaped recess comprises a surface coated with a reflective material.

Example 6 is the illumination structure of any example herein, particularly example 4, wherein a cone shaped structure is situated within the cone shaped recess, and wherein the cone shaped structure has a shape and a size that matches a shape and a size of the cone shaped recess.

Example 7 is the illumination structure of any example herein, particularly example 6, wherein the cone shaped structure comprises at least one surface that is coated with a reflective material, or polished.

Example 8 is the illumination structure of any example herein, particularly example 6, wherein the cone shaped recess comprises an apex angle between 10 degrees and 120 degrees and wherein the cone shaped structure comprises an apex angle between 10 degrees and 120 degrees.

Example 9 is the illumination structure of any example herein, particularly example 1, wherein the second end comprises a curved surface.

Example 10 is the illumination structure of any example herein, particularly example 9, wherein the curved surface is parabolic or spherical.

Example 11 is the illumination structure of any example herein, particularly example 9, wherein the curved surface is coated with a reflective material.

Example 12 is the illumination structure of any example herein, particularly example 1, wherein the second end comprises a flat surface.

Example 13 is the illumination structure of any example herein, particularly example 2, wherein the light emitting diode is coupled with a heat sink.

Example 14 is the illumination structure of any example herein, particularly example 1, wherein the light transmitting material comprises an acrylic, a polycarbonate, or a glass material.

Example 15 is the illumination structure of any example herein, particularly example 1, wherein when the light pipe extends into the showerhead, the light pipe extends through an entrance hole and into a cavity within the showerhead.

Example 16 is an illumination structure comprising: a light source; and a rod comprising a hole, a first end, and a second end, wherein the hole is along a longitudinal direction of the rod,, wherein the first end of the rod is to couple with the light source, wherein the light source at least partially covers the hole, and wherein the second end of the rod is configured to extend at least partially into an entrance hole of a showerhead.

Example 17 is the illumination structure of any example herein, particularly example 16, wherein the rod is cylindrical, rectangular, or triangular, and wherein the light source extends through the entrance hole into a cavity within the showerhead.

Example 18 is the illumination structure of any example herein, particularly example 16, wherein the rod comprises a thermally conductive material.

Example 19 is the illumination structure of any example herein, particularly example 16, wherein the rod further comprises a thermal insulator within the hole.

Example 20 is the illumination structure of any example herein, particularly example 19, wherein the light source comprises one or more light emitting diodes.

Example 21 is the illumination structure of any example herein, particularly example 19, wherein the thermal insulator comprises ceramic.

Example 22 is a method of operating an apparatus to determine hole blockage in a showerhead, the method comprising: operating an illumination structure to direct light through an entrance hole and into a cavity within a showerhead; collecting the light emanating from exit holes in the cavity, wherein the exit holes are opposite to the entrance hole; and measuring intensity of the light emanating from the exit holes to determine blockage of the exit holes.

Example 23 is the method of any example herein, particularly example 22, wherein the illumination structure comprises a light source and a rod, wherein an end of the rod is coupled with the light source.

Example 24 is the method of any example herein, particularly example 23, wherein the rod is a light pipe comprising a light transmitting material, the light source comprises a light emitting diode, and an end of the light pipe is coupled with the light emitting diode.

Example 25 is the method of any example herein, particularly example 24, wherein operating the illumination structure further comprises inserting at least a portion of the light pipe through the entrance hole and into the cavity.

Example 26 is the method of any example herein, particularly example 25 further comprises inserting the portion of the light pipe at least 1 mm above an inner surface of the cavity.

Example 27 is the method of any example herein, particularly example 26, wherein the cavity further comprises a plate between the entrance hole and the exit holes, and wherein prior to collecting the light emanating from the exit holes in the showerhead, the light reflects from the plate and the inner surface.

Example 28 is the method of any example herein, particularly example 24, wherein collecting the light emanating from the exit holes further comprises placing a sheet comprising a photosensitive material adjacent to the exit holes and recording the light impinging on the sheet.

Example 29 is the method of any example herein, particularly example 24, wherein using the illumination structure further comprises: producing a first light with a first intensity from the light emitting diode and measuring a first spread of intensity of the first light emanating from the exit holes; producing a second light with a second intensity from the light emitting diode and measuring a second spread of intensity of the second light emanating from the exit holes; and comparing the first spread of intensity of the first light and the second spread of intensity of the second light to determine the hole blockage.

Example 30 is a method of operating an apparatus to determine hole blockage in a showerhead, the method comprising: operating an illumination structure to direct light into a cavity within the showerhead; collecting the light emanating from exit holes in the showerhead; and analyzing intensity of the light emanating from the exit holes to determine blockage of the exit holes.

Example 31 is the method of any example herein, particularly example 30, wherein the illumination structure comprises a light source and a rod, wherein an end of the rod is coupled with the light source.

Example 32 is the method of any example herein, particularly example 31, wherein the rod comprises a light pipe, the light pipe comprising a light transmitting material, wherein the light source comprises a light emitting diode, and wherein an end of the light pipe is coupled with the light emitting diode.

Example 33 is the method of any example herein, particularly example 32, wherein operating the illumination structure further comprises inserting at least a portion of the light pipe into the cavity through an entrance hole, wherein the entrance hole is opposite to the exit holes.

Example 34 is the method of any example herein, particularly example 33, further comprises inserting the portion of the light pipe at least 1 mm above an inner surface of the cavity.

Example 35 is the method of any example herein, particularly example 30, wherein collecting the light emanating from the exit holes further comprises placing a sheet comprising a photosensitive material adjacent to the exit holes and recording the light impinging on the sheet.

Example 36 is the method of any example herein, particularly example 32, wherein the method further comprises: producing a first light with a first intensity from the light emitting diode and measuring a first spread of intensity of the first light emanating from the exit holes; producing a second light with a second intensity from the light emitting diode and measuring a second spread of intensity of the second light emanating from the exit holes; and comparing the first spread of intensity of the first light and the second spread of intensity of the second light to determine the hole blockage.

Example 37 is the method of any example herein, particularly example 31, wherein the rod comprises a hollow opening, wherein an end of the rod is coupled with the light source, and wherein the light source covers the hollow opening.

Example 38 is the method of any example herein, particularly example 36, wherein the rod comprises a conductive material that transfers heat from the light source to a heat sink coupled with the rod.

Example 39 is the method of any example herein, particularly example 36, further comprises inserting at least a portion of the light source into the cavity through an entrance hole, and wherein the entrance hole is opposite to the exit holes.

Example 40 is the method of any example herein, particularly example 38, further comprises inserting a portion of the light source at least 1 mm above an inner surface of the cavity.

Example 41 is the method of any example herein, particularly example 36, wherein the light source is a light emitting diode, wherein the light emitting diode directs light axially away from hollow opening of the rod.

Example 42 is the method of any example herein, particularly example 40, wherein the method further comprises: producing a first light with a first intensity from the light emitting diode and measuring a first spread of intensity of the first light emanating from the exit holes; producing a second light with a second intensity from the light emitting diode and measuring a second spread of intensity of the second light emanating from the exit holes; and comparing the first spread of intensity of the first light and the second spread of intensity of the second light to determine blockage of the exit holes.

Example 43 is a method of operating an apparatus to measure hole blockage in a showerhead, the method comprising: operating an illumination structure to direct light into a cavity within the showerhead, wherein the showerhead further comprises an entrance hole, exit holes opposite the entrance hole, a gas diffusion plate in the cavity between the entrance hole and the exit holes, a deflector coupled with the gas diffusion plate; and collecting light emanating from the exit holes.

Example 44 is the method of any example herein, particularly example 43, wherein the deflector is conical, or pyramidal in shape, wherein an apex of the deflector faces the entrance hole.

Example 45 is the method of any example herein, particularly example 43, wherein operating the illumination structure comprises inserting a plurality of fiber optic cables through the entrance hole and into the cavity and deflecting light from the gas diffusion plate and a wall of the cavity into at least some of the exit holes.

Example 46 is the method of any example herein, particularly example 45, wherein inserting the plurality of fiber optic cables comprises bringing into contact with the deflector.

Example 47 is the method of any example herein, particularly example 46, wherein inserting the plurality of fiber optic cables comprises bringing into contact with the gas diffusion plate.

Example 48 is the method of any example herein, particularly example 44, wherein the apex is at least 1 mm away from an edge of the entrance hole.

Example 49 is the method of any example herein, particularly example 43, wherein the illumination structure comprises a light source and a rod, wherein an end of the rod is coupled with the light source.

Example 50 is the method of any example herein, particularly example 49, wherein the rod is a light pipe comprising a light transmitting material, wherein the light source comprises a light emitting diode, and wherein an end of the light pipe is coupled with the light emitting diode, and wherein using the illumination structure further comprises extending the light pipe into the entrance hole and deflecting the light from the deflector and from a wall of the cavity into the exit holes.

Example 51 is the method of any example herein, particularly example 43, wherein the illumination structure comprises a light source, and wherein using the illumination structure comprises transmitting the light from the light source into the entrance hole and deflecting the light from the deflector and from a wall of cavity into the exit holes.

Example 52 is the method of any example herein, particularly example 50, wherein using the light pipe further comprises: producing a first light with a first intensity from the light emitting diode and measuring a first spread of intensity of the first light emanating from the exit holes; producing a second light with a second intensity from the light emitting diode and measuring a second spread of intensity of the second light emanating from the exit holes; and comparing the first spread of intensity of the first light and the second spread of intensity of the second light to determine the hole blockage.

What is claimed is:

1. An illumination structure comprising:
a light source; and
a light pipe comprising a light transmitting material, a first end, and a second end, wherein the first end of the light pipe is configured to couple to the light source and the second end is configured to extend at least partially into a showerhead.

2. The illumination structure of claim 1, wherein the light source is a light emitting diode.

3. The illumination structure of claim 1, wherein the light pipe is a cylindrical structure, a conical structure, a frustoconical structure, or a rectangular structure.

4. The illumination structure of claim 1, wherein the second end comprises a cone-shaped recess.

5. The illumination structure of claim 4, wherein the cone shaped recess comprises a surface coated with a reflective material.

6. The illumination structure of claim 4, wherein a cone shaped structure is situated within the cone shaped recess, and wherein the cone shaped structure has a shape and a size that matches a shape and a size of the cone shaped recess.

7. The illumination structure of claim 6, wherein the cone shaped structure comprises at least one surface that is coated with a reflective material, or polished.

8. The illumination structure of claim 6, wherein the cone shaped recess comprises an apex angle between 10 degrees and 120 degrees and wherein the cone shaped structure comprises an apex angle between 10 degrees and 120 degrees.

9. The illumination structure of claim 1, wherein the second end comprises a curved surface.

10. The illumination structure of claim 9, wherein the curved surface is parabolic or spherical.

11. The illumination structure of claim 9, wherein the curved surface is coated with a reflective material.

12. The illumination structure of claim 1, wherein the second end comprises a flat surface.

13. The illumination structure of claim 2, wherein the light emitting diode is coupled with a heat sink.

14. The illumination structure of claim 1, wherein the light transmitting material comprises an acrylic, a polycarbonate, or a glass material.

15. The illumination structure of claim 1, wherein when the light pipe extends into the showerhead, the light pipe extends through an entrance hole and into a cavity within the showerhead.

16. An illumination structure comprising:
a light source; and
a rod comprising a hole, a first end, and a second end, wherein the hole is along a longitudinal direction of the rod, wherein the first end of the rod is to couple with the light source, wherein the light source at least partially covers the hole, and wherein the second end of the rod is configured to extend at least partially into an entrance hole of a showerhead.

17. The illumination structure of claim 16, wherein the rod is cylindrical, rectangular, or triangular, and wherein the light source extends through the entrance hole into a cavity within the showerhead.

18. The illumination structure of claim 16, wherein the rod comprises a thermally conductive material.

19. The illumination structure of claim 16, wherein the rod further comprises a thermal insulator within the hole.

20. The illumination structure of claim 19, wherein the light source comprises one or more light emitting diodes.

21. The illumination structure of claim 19, wherein the thermal insulator comprises ceramic.

22. A method of operating an apparatus to determine hole blockage in a showerhead, the method comprising:
operating an illumination structure to direct light through an entrance hole and into a cavity within a showerhead;
collecting the light emanating from exit holes in the cavity, wherein the exit holes are opposite to the entrance hole; and
measuring intensity of the light emanating from the exit holes to determine blockage of the exit holes.

23. The method of claim 22, wherein the illumination structure comprises a light source and a rod, wherein an end of the rod is coupled with the light source.

24. The method of claim 23, wherein the rod is a light pipe comprising a light transmitting material, the light source comprises a light emitting diode, and an end of the light pipe is coupled with the light emitting diode.

25. The method of claim 24, wherein operating the illumination structure further comprises inserting at least a portion of the light pipe through the entrance hole and into the cavity.
